(19) United States
(12) Patent Application Publication
(10) Pub. No.: US 2008/0313052 A1
(43) Pub. Date: Dec. 18, 2008

(54) Method and system for managing transactions initiated via a wireless communications device

(75) Inventors: Jonathan Otto, Palm Beach, FL (US); Andrew Van Luchene, Santa Fe, NM (US); Michael R. Mueller, San Francisco, CA (US); Raymond J. Mueller, Palm Beach Gardens, FL (US)

Correspondence Address: SIMPSON & SIMPSON, PLLC, 5555 MAIN STREET, WILLIAMSVILLE, NY, 14221-5406, US

(73) Assignee: RetailDNA, LLC, West Palm Beach, FL (US)

(21) Appl. No.: 12/151,040

(22) Filed: May 2, 2008

Related U.S. Application Data
(63) Continuation-in-part of application No. 11/983,679, filed on Nov. 9, 2007.
Application No. 11/983,679 is a continuation-in-part of application No. 09/993,228, filed on Nov. 14, 2001.

(51) Int. Cl. G06Q 30/00

(52) U.S. Cl. 705/26

(57) ABSTRACT

A system for managing an order received from a wireless communications device (WCD), including: an order element, in a processor in at least one specially programmed general-purpose computer, arranged to receive, via an interface element in the computer, a transmission, via a communication network, from the WCD, including an order for an item at a retail location; a location element, in the processor, to identify, using the interface element and the processor, that the WCD is within a predetermined location with respect to the location; a scheduling element, in the processor, to schedule preparation of the order in response to the predetermined location; an instruction element, in the processor, to generate at least one instruction for fulfilling the order and to transmit the instruction, using the interface element; and, a presentation element, at a point of sales (POS) station at the retail location, to receive and present the instruction.

### CROSS-REFERENCE TO RELATED APPLICATIONS

This is a continuation-in-part patent application under 35 USC 120 of a continuation-in-part of U.S. patent application Ser. No. 11/983,679, filed Nov. 9, 2007 and entitled “Method and System for Generating, Selecting, and Running Executables in a Business System Utilizing a Combination of User Defined Rules and Artificial Intelligence” which is a continuation-in-part patent application under 35 USC 120 of U.S. patent application Ser. No. 09/993,228, filed Nov. 14, 2001 and entitled “Method and apparatus for dynamic rule and/or offer generation,” which applications are incorporated herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to a method and a system to process and execute, at a point of sales (POS) station, an order remotely placed using a wireless communications device (WCD).

### BACKGROUND OF THE INVENTION

It is known to use a WCD to contact a business location to place an order. Unfortunately, there is not a system or method to automatically coordinate and execute a transaction, at a POS, for fulfilling the order.

Thus, there is a long-felt need to provide a system and a system to automatically coordinate and execute a transaction, at a POS, for fulfilling a remotely placed order from a WCD.

### SUMMARY OF THE INVENTION

The invention broadly comprises a system for managing an order received from a wireless communications device (WCD), including: an order element, in a processor in at least one specially programmed general-purpose computer, arranged to receive, via an interface element in the at least one specially programmed general-purpose computer, a transmission, via a communication network, from a WCD, the transmission including an order for an item at a retail location; a location element, in the processor, arranged to identify, using the interface element and the processor, that the WCD is within a predetermined location with respect to the retail location; a scheduling element, in the processor, arranged to schedule preparation of the order in response to the predetermined location; an instruction element, in the processor, arranged to generate at least one instruction for fulfilling the order and to transmit the at least one instruction, using the interface element; and, a presentation element, at a point of sales (POS) station at the retail location, arranged to receive and present the at least one instruction.

In one embodiment, the location element is arranged to determine that the WCD is in a drive-through line for the retail location or walk-up line for the retail location. In another embodiment, the location element is arranged to determining that the WCD is in a specified position in the drive-though line or the walk-up line, respectively. In a further embodiment, the scheduling element is arranged to schedule in response to the specified position in the drive-though line or the walk-up line, respectively. In one embodiment, the location element is arranged to determine whether the order is ready and is further arranged to: if the order is ready, transmit to the communication network for transmission to the WCD, using the interface element, a notice that the order is ready; and if the order is not ready, transmit to the communication network for transmission to the WCD, using the interface element, a notice that the order is not ready and an estimate of when the order is expected to be ready.

In one embodiment, the at least one instruction includes information that the order has already been placed via the WCD. In another embodiment, the at least one instruction includes a prompt to confirm that the order was placed via the WCD and wherein the order element is arranged to receive, via the interface element, a transmission from the POS indicating that the order was placed via the WCD. In a further embodiment, the at least one instruction includes a prompt to ask if the order was placed via the WCD and wherein the order element is arranged to receive, via the interface element, a transmission from the POS indicating that the order was placed via the WCD.

In one embodiment, the order element is arranged to receive, via the interface element, a transmission, via the communication network, from the WCD, the transmission including payment information or authorization regarding the order and wherein the at least one instruction includes directions regarding payment for the order. In another embodiment, the scheduling element is arranged to schedule based on an estimated time of arrival for the WCD at the business location or in response to a signal transmitted from the WCD and received via the interface element. In a further embodiment, the order element is arranged to transmit, using the processor and the interface element, an order confirmation to the communication network for transmission to the WCD, the order confirmation including an estimated time of arrival from a location of the WCD to the business location or directions from the location of the WCD to the business location. In a preferred embodiment, the POS station is manned or is a self-service kiosk.

In one embodiment, the order element is arranged to: generate, using the processor, a listing of retail locations able to fulfill the order; transmit, using the interface element, the listing to the WCD via the communications network; and receive, using the interface element, a transmission from the WCD via the communications network, the transmission including a selected retail location from the listing of locations. Then, the location element is arranged to identify that the WCD is within a predetermined location with respect to the retail location and the display element is arranged to display the at least one instruction at a POS station at the selected retail location.

The invention also broadly comprises a method for managing an order received from a wireless communications device (WCD).

It is a general object of the present invention to provide a method and a system to automatically coordinate and execute a transaction, at a POS, for fulfilling a remotely placed order from a WCD.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention system for managing an order received from a wireless communications device (WCD);

FIG. 2 is a flow chart of a present invention method for managing an order received from a WCD;

FIG. 3 is a schematic block diagram of a present invention apparatus for managing an order received from a WCD; and,

FIG. 4 is a flow chart of a present invention method for managing an order received from a WCD.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

The following non-limiting definitions are applicable to the present invention:

Business—includes any business enterprise formed for the purpose of providing a product or service, which may or may not be for profit.

Business objective—includes any desired outcome of a business or business owner, including, for example, acquisition of new customers, delivery of one or more marketing offers, increases or improvements in product quality or service, sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Business Information—includes any information that is provided, known, gathered, assumed or is otherwise determined or stored that is related to or is about or otherwise helps understand, define, operate, improve, track or report the performance of, a business, for example, customer acquisition and sales data, marketing information, click-through rates, conversion rates, profit and loss information, accounting information, financial information, statistics and ratios, customer information, sponsor information, information about any one or more business, customer or sponsor objectives, or any other information, business metrics and data gathered or stored or otherwise possessed or accessible by a business and/or any of its affiliates, sponsors, customers or investors.

Controller—means any one or more of the following electronic devices including, but not limited to: cell phones, Personal Digital Assistants or (PDA's), Blackberry or similar devices, such as hand held computers, MP3 players, or any other personal electronic device that has one or more of a keyboard, speaker, microphone, one or more buttons, or any other similar devices that provides a User with Input and/or Output Functionality and Remote Connectivity. A Controller may be or include one or more of a Display and/or a Server or other computing devices or means of computing.

Coupon—includes an offer presented in the form of an electronic or printed ticket or document which may include a discount or rebate when purchasing one or more products from a business or sponsor. In certain embodiments, a coupon may include a bar code, RFID, or other means of identification, which may include information that can verify any one or more of the type of coupon, valid offer dates, customer, business or sponsor information, discount amounts, restrictions, permissions, items required to purchase to receive a discount or rebate, and/or items to which a discount or rebate applies, location information, including where the coupon is valid, e.g., which store or stores, or website, and/or any other information that might assist or be of benefit to the issuer or recipient or the processor, e.g., a cashier, and/or the processing system, e.g., a POS terminal or POS system, and/or a sponsor or other business entity, and/or any information that might encourage distribution, delivery, redemption or use of any such coupon or that might improve the results of any coupon or coupon marketing campaign, e.g., a viral marketing campaign or new product introduction.

Customer Facing Display—includes any device accessible by an end user or customer that includes at least one of a display, input means, e.g., a touch screen or keyboard, or other output means, e.g., a speaker. In certain embodiments, a Customer Facing Display may include a Kiosk, POS Terminal, or other computing device, such as a cell phone, PDA, laptop or PC. In certain embodiments a customer facing display may be a POS or POS terminal and vice versa.

Customer Identifier—includes, but is not limited to a cell phone, an RFID tag, a credit card, a debit card, a frequent shopper card or number, a coupon, a license plate, a check, a loyalty or gift card, fingerprint or other biometric input, a driver's license, or other identification means.

Customer Information—includes any information that is provided, known, gathered, assumed or is otherwise determined or stored that is related to or is about or otherwise helps understand or define a customer and/or a customer's buying habits, preferences or tendencies. Such information may include the customer's (or any related person, e.g., a child) order history, order contents, ideal order acceptance or rejection data, willingness to accept or reject one or more marketing offers or messages (either specific or types or categories of offers), price point or price elasticity, tendency to attempt to game other otherwise attempt to take advantage of the system or marketing program, average order total, e.g., average check, average item count, e.g., average number of items in a given order, average customer count, e.g., how many persons in the party on average, any demographic information, e.g., income, race, mailing address, zip codes, phone numbers, household total income, number of children, age, sex, number and type of internet enabled devices, participation in one or more marketing programs, willingness to use kiosks, cell phones or other ordering devices, prior ordering history, including willingness or tendency to accept pre, mid and/or post order marketing offers, e.g., suggestive selling, cross selling, sponsor rewards, or any other offers, and/or any other information gathered or provided by/from the customer, e.g., preferences information gathered by observing such customer behavior, e.g., does customer switch from cold beverages to hot beverages in the wintertime, and/or information gathered or supplied by a marketing program and/or by such customer when signing up or otherwise maintaining such information in a customer loyalty or other marketing program's database, or by importing or otherwise accessing information about such customer via any public or commercially accessible database and/or any combination of the foregoing information.

Customer Objective—includes any desired outcome, behavior that benefits a customer, including, for example, improved or better pricing, service, e.g., friendly service, speed of service, accuracy of service, quality of delivered products, types of marketing offers and/or savings associated with each, cleanliness of location, type of online or other ordering systems, including, e.g., POS devices, or any other favorable treatment or benefit that can be obtain or otherwise accrues to the benefit of such customer, and/or any combination of the foregoing.

Dilution—includes any outcome that has a net negative effect, e.g., an acceptance of an upsell or other offer results in providing a discount on an item, which a customer might otherwise have paid full price.

Discount—includes any price or offer at an amount other than the standard list price or expected price or shelf price, or displayed price, e.g., online.

Display—includes any one or more of the following electronic devices including, but not limited to: TV (of any technology type, including but not limited to a Plasma Display, LCD, CRT or DLP), Kiosk, LED display, Electronic Shelf Label, Automated Teller Machine (ATM), POS terminal, video game display, video slot machine or other video based casino games, speaker, or any other device capable of displaying, presenting or otherwise outputting or processing Output Materials (such as an LCD or other display in an airline seatback or other Location, e.g., a grocery cart equipped with a display and/or a bar code or RFID printer or reader), including devices that provide a User with Output Functionality. A Display may include or be one or more of a Controller and/or a Server and/or other computing device capable of providing Input and/or Output Functionality and/or Remote Connectivity.

Domain Name Server (DNS)—One or more computers including a cooperatively run set of databases, distributed among several servers, volunteered as repositories for IP address information.

End User—includes any person or entity making use of any one or more of the methods of the disclosed invention, and/or any system that uses or is based upon or benefits from one or more of the disclosed inventions, including, for example, customers, vendors, retailers, QSR operators, managers, employees, supervisors, friends, family members, or any other person as applicable to the given context or otherwise.

Existing Member—includes a member of a loyalty program or other marketing program and/or a person that has signed up for any marketing or other program and/or has provided information to such a program, whether or not such person is aware of such program, including, end users.

Frequent Shopper Program—includes any system that provides one or more rewards to members of such program for purchases made.

Frequency Program—includes any Frequent Shopper Program or other rewards system that rewards customers for their frequency of visit and/or buying one or more products, goods or services.

GUI—includes a graphical user interface, or other means of providing communications from or to an end user, including via graphics, text, audio, video, data input, such as voice, typing, touch screen, or other means of input or output to/from any device, including a POS Terminal, or other computing devices. Such GUI may include information and/or actions that are available for viewing, use or interaction with an end user. Such interaction may be accomplished via any applicable means, including, for example, manipulating icons, widgets or other items or areas displayed on such GUI, including, clicking on one or more hyperlinks, and/or entering information into fields or other areas designed for such purposes, e.g., typing a name, or selecting one or more items from a displayed list, etc.

Header—A numeric code assigned to a request for content by either a LAN or ISP Server, which identifies a requestor's unique Internet Protocol Address. Generally, the Header is used for purposes of accurately returning a requested Mark-up Language-based electronic document as well as any corresponding files to the requestor.

Hyperlink—A text phrase or graphic embedded within a markup language-based electronic file, which corresponds to the address of a site on the World Wide Web.

Input Functionality—includes any one or more of any of the following, including but is not limited to any device that includes or provides one or more buttons (e.g., a keyboard) that can convey individual or grouped electrical signals, impulses, commands, or messages, or other tactile or other input device including a joy stick, mouse, touch screen, and/or audio (e.g., voice commands or instructions), bar code scanner, RFID reader, fingerprint or other biometric scanning device, scale, laser pointer, camera, infrared sensor, cell phone, hand held computer or PDA keypad, motion or other “presence” detector, magnetic card or magnetic card reader, and any other input method recognizable by or able to convey information to any one or more of a Display, Server, Controller or other computing device.

Internet—includes the world wide web and the network that is accessible by the public that includes a network of interconnected computers that transmit data using, for example, Internet Protocol (IP). In some aspects, certain private networks, including virtual private networks (VPN) may be included in the definition of the Internet.

Internet Device or Internet Enabled Device—includes any computing device that is capable of accessing or otherwise communicating with or via the Internet or any other network, client/server and/or peer-to-peer or any other network, and/or that is otherwise able to practice or benefit from any one or more of the herein disclosed inventions.

Internet Ordering or Online Purchase—includes the processing, in whole or in part, of any one or more transactions using or otherwise communicating via the Internet or other means of communications by or between any one or more of a business, sponsor and/or one or more customers, which transaction may be for or include the purchase, trade or acquisition of one or more items. In certain embodiments, internet ordering or online purchases may include the delivery of one or more marketing messages or marketing offers.

Item—includes any object, tangible or intangible, which may include any item for sale, rental, lease, consumption, transfer, and/or may be possessed or owned. Item may include any physical or virtual object. In certain embodiments an item may be any one or more of a food item, a beverage item, a dessert item, a retail good, a food product, a device, a POS device, a coupon, clothing, furnishings, groceries, automobiles, motorcycles, lighting, electrical equipment or devices, etc.

Kiosk—includes any device or location that permits a customer or end user to enter part or all of an order and/or respond to a marketing message or offer, with or without the assistance of a third party, e.g., a cashier. Kiosks may include software to prevent end users from performing unauthorized actions and/or accessing the system, operating system or other secure areas of the kiosk and/or systems to which it may be attached or connected, e.g., the Internet or one or more servers, etc.

Location—means and includes, but is not limited to retail stores, restaurants, bars, theme parks, casinos, video game parlors, Internet Café's, coffee bars, book stores, gas stations, convenience stores, hotel rooms, hotel or other lobbies, meeting rooms, office buildings, offices, airports, airplanes, government or other public services buildings, hospitals or any other public or private area or facility or residence that contains, possesses or otherwise provides limited or general access to at least one Display and/or practices part or all of any one or more embodiments of the present invention.

Loyalty or Frequent Shopper Member—includes any end user or person that has joined or signed up or opted into a loyalty program and/or frequent shopper program.

Loyalty Member—a person that has signed up for or otherwise participates in a loyalty or frequent shopper program.

Loyalty Program—any system that permits users to sign up to receive rewards based upon such user's purchases or visitation frequency.

Marketing Message—Includes a marketing offer, or any other communication with an end user, e.g., a customer, which message may include any one or more of the following such as, any one or more of a graphic, logo, icon, price, discount or other offer, video, audio, or other visual, audio or static marketing or other content designed to communicate with or otherwise inform, educate or persuade a User. In certain embodiments, a marketing message may include one or more marketing offers.

Marketing Offer or Offer—includes any offer for sale of any item, good, product or service.

Marketing Program—includes any system that provides marketing messages, marketing content, loyalty programs, coupons, discounts, or any other offers or marketing offers, and/or tracks customer buying habits and other information, including customer information, such as locations, travels, demographics, ordering preferences, etc.

Markup Language—A set of codes in a text file that instructs a computer how to format the file for purposes of printing and/or display, as well as how to index and link the content of the file. Example markup languages include HTML, SGML, XML, VRML, and NRML.

Network Device—includes any device that can be interfaced with a technology network, for example, the Internet, a wireless communications network, (e.g., a cellular telephone system), a LAN, or a WAN.

Optimized—includes determining which marketing offer will likely or generally achieve the desired results or maximum results among or given one or more of several complimentary or competing objectives, including, for example, sales volume, gross margin, profits, customer accept rates, average check, speed of service times, product quality, freshness, customer satisfaction, customer frequency, order point, destination point or any other variables that affect or are of interest to one or more affected parties, e.g., the retail establishment, its suppliers and/or the customer. In certain embodiments, optimized includes finding the maxima or minima of a given function. In certain embodiments, the terms optimized and optimal have corollary meanings.

Output functionality—includes transmission of information via Remote Connectivity and/or conveying Output Materials on a Display and/or tactile feedback.

Output Materials means any one or more of the following, including but is not limited to any one or more of, Marketing Messages, audio, still images and/or video, flash and/or other animated sequences or materials, printed or visual reports or receipts, displayed information, information recorded to or stored on a hard drive or other computer readable medium, a text message, voice mail message, a sound such as a beep or bell or buzzer, audio messages (e.g. a voice prompt or marketing message or other information), including recorded, actual or synthetic voice messages, or any other output generated by a Display, Server, Controller, Network or other device or application that is sent to or processed by a User, Display, Server, Controller, Network or other device for subsequent viewing, listening and/or further processing or storage.

PC—includes a personal computer, such as a laptop, such as one provided by Dell Computers.

PDA—includes a personal digital assistant, such as Palm Pilot, or any other personal computing device, which includes at least one of a display, processor, memory or input or output means.

Point of Sale—includes any Point of Sale system or device that permits an end user to start, enter or complete an order or sales transaction, such as Panasonic's 7900 “all in one”, or any other POS devices, terminals or systems, websites, kiosks, PCs, PDAs, Cell Phones, call centers, slot machines, vending machines, and/or any other Internet or other device that provides access to any of the functionality or inventions disclosed herein and or any of the same or similar functionality and/or otherwise permits an end user to practice or benefit from any of the disclosed inventions. Point of Sale and POS shall have corollary meanings.

POS Device, includes a POS or other physical device that provides access to any of the features or inventions disclosed herein and or any of the same or similar functionality and/or otherwise permits an end user to practice or benefit from any of the disclosed inventions.

POS Terminal—includes a POS or other physical device that provides access to any of the foregoing and or any of the same or similar functionality and/or otherwise permits an end user to practice or benefit from any of the disclosed inventions.

Product—includes any machine, manufacture and/or composition of matter, unless expressly specified otherwise.

Prospective Member—includes any person that is not currently a member.

Referral—includes any prospective member identified or otherwise provided by an existing member.

Proximal, Proximity, Proximal/Proximity Data—includes any information about an end user's current or predicted whereabouts. Such information may include distance, i.e., distance between two points, e.g., a retail location and the end user, which distance may be measured directly, e.g., point A to point B, or based upon travel means, e.g., based upon the streets or other paths that a person or end user could actually use to travel from said point A to said point B, and/or may be based upon time, e.g., how long it might take a given end user to travel said distance between point A and point B, perhaps further as determined by such end user's current rate of travel or average rate of travel or method of travel, etc. Methods to calculate distances between to points in space and/or to estimate travel time are well known by those of ordinary skill in the art.

Referral Coupon—includes a marketing message, marketing offer, or other offer, including, for example, a coupon provided to an existing member for providing the identity or other information of a prospective member and/or an action taken by such prospective member, including, for example, such prospective member becoming a member and/or accepting a similar or other marketing offer, e.g., by redeeming a coupon.

Response—includes any action and/or failure to act by any person. For example, a response from a prospective member includes the immediate or subsequent reply to or use of one or more marketing messages or offers or other response, which response includes, but is not limited to, for example, signing up to one or more loyalty, frequency or other marketing programs, acceptance and/or use, e.g., redemption, of any one or more offers or coupon, opting in to one or more loyalty, frequency or other marketing program(s), achieving or maintaining a certain level of sales and/or number or frequency of store visits, purchases of certain products, providing one or more email addresses, visiting one or more retail, restaurant or other store location(s), ordering one or more items, or specific items, or failure to order one or more items or specific items, filling out a form or forms, or providing additional information, such as mailing address, phone number, internet device id information, and/or signing up for one or more third party sponsor programs, and/or any other action as determined or established by the marketing program, pressing one or more buttons and/or clicking on one or more hyperlinks or any combination of the foregoing. The terms response and respond shall have corollary meanings. In some embodiments a referral coupon may be a reward and/or a reward may be a referral coupon. In certain embodiments a referral coupon may be a viral coupon and vice versa.

Reports—in certain of the disclosed embodiments, one or more reports may be developed to provide tracking and/or analysis relating to any one or more data elements associated with any such embodiment or invention. Reports include any feedback or communication requested by or delivered to one or more end users, which may or may not require authorization to receive such report. Reports can be printed, verbalized using a text to speech conversion program, or displayed on any device, including, for example, a POS terminal or other computing device. Such reports may be created and/or delivered using any applicable means available. The methods to create and deliver reports are well understood and known within the industry and are disclosed in the prior art. Reports may be demand request, i.e., a report is generated only when or as requested, or exception based, i.e., a report is generated if a certain condition or conditions are met, not met or change in any defined way. In certain embodiments, reports are generated whenever desired or otherwise indicated or scheduled, and may be stored for subsequent use, which use may or may not be based on a request by an end user. Reports may include any one or more available database elements and/or calculated results based upon any one or more of the databases, database elements, mathematical or statistical manipulations, and/or any of the methods disclosed herein and/or as understood by any person skilled in the art and/or as requested/designed by one or more end users or other authorized personnel. For example, a report may include any one or more pieces of information contained or relating to customer, business or sponsor information, and/or POS transaction data and/or any or all results information generated or associated with any marketing offer or message.

Reward—includes any item or object or incentive that is or might be of benefit to its recipient, for example, a free or discounted item or a financial incentive, presented to an end user, e.g., an existing loyalty or marketing program member. In certain embodiments, rewards may be provided without any action of or by the recipient to receive such reward. In other embodiments, recipients must perform certain actions, e.g., purchase items from a business, or make a commitment to make such purchases, in order to receive, earn or otherwise qualify for any such reward(s). In some embodiments, a reward may be cash or an offer of cash or other financial currency or benefit. In certain embodiments, a reward may be an item, such as a toy, or a coupon. In yet other embodiments, a reward may be a combination of any or all of the foregoing. In certain embodiments, rewards may be created, funded or otherwise provided by businesses or sponsors. Rewards may be offered and/or delivered using any applicable means, including electronic transmission via the Internet, cell phones, text or voice mail, and may include one or more marketing messages or marketing offers. Rewards may be issued, granted or provided by individuals or groups and/or delivered or provided to individuals or groups. In certain embodiments, recipients of one or more rewards may be required to perform a certain task or tasks to qualify and/or to make use of one or more rewards. In some embodiments, rewards may be used only by the specific individual(s) who received the reward. In addition or in the alternate, rewards may be transferable or do not specify the recipient or require that only the recipient may benefit from such reward(s). In some embodiments a coupon may be a reward and/or a reward may be a coupon.

Viral Reward—includes any reward, coupon or other incentive designed to encourage additional use of such reward and/or to encourage one or more additional persons to join a loyalty or marketing program and/or to help achieve any other business, sponsor or customer objective(s). In some embodiments, viral rewards may be communicated via any applicable means, including, for example, via email, voice mail or text based messaging services. The terms viral reward, network reward, viral coupon, and network coupon shall have corollary meanings.

RFID—includes a radio frequency identification tag, transponder or similar devices.

Router—An intermediary device within a communications network that expedites message delivery. Within a single network linking many computers through several possible connections, a router receives transmitted messages and forwards them to their correct destination via an efficient available route.

Sensor—includes any application or device that can make a determination or otherwise detecting the change, presence or absence of something, including, for example, temperature, weight, sound, pressure, volume, mass, light, odors, and/or any recording, or registration, change, presence or absence of or to any data or other electronic media. In certain embodiments a sensor includes one or more transducers.

Sponsor—includes any third party or entity that provides product, goods or services and/or money or other financial means to an end user or retail entity in exchange for the option to communicate with such end user, including, for example, to provide one or more marketing messages or offers, including, e.g., a cross sell offer or sponsor reward.

Store—includes any one or more retail, restaurant or other location, and may include online locations, websites, kiosks, automated stores, e.g., vending machines, so called “brick and mortar” locations, and/or any combination of the foregoing, and/or access to any such location(s) using any POS device.

Sponsor information—includes any information that is provided, known, gathered, assumed or is otherwise determined or stored that is related to or is about or otherwise helps understand, define, operate, improve, track or report the performance of, a sponsor business, for example, customer acquisition and sales data, marketing information, click-through rates, conversion rates, profit and loss information, accounting information, financial information, statistics and ratios, customer information, sponsor information, information about any one or more sponsor objectives, or any other information, business metrics and data and/or business information gathered or stored or otherwise possessed or accessible by a sponsor and/or any of its affiliates, businesses, customers or investors.

Sponsor objective—includes any desired outcome of a sponsor or sponsor business owner, including, for example, acquisition of new customers, conversion of competitor's customers to sponsor's customers, delivery of one or more marketing messages or offers, increases or improvements in sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Subscription—includes an agreement, which may be implicit or explicit, to purchase a certain quantity of goods, services, products or items and/or purchase the rights to use or access such goods, services, products or items, during or over a specified period of time, and/or an agreement to spend a certain amount of money over a certain period. In certain embodiments, subscriptions may be accepted through an action or failure to act by a subscriber or end user. In certain embodiments, subscriptions may automatically renew based upon an action or inaction of a subscriber or end user. In certain embodiments, a virtual subscription may be accomplished without formal agreement among the affected parties, e.g., by selling a razor that requires use of specific blades.

Tag—A code embedded within an markup language-based electronic file which associates one or more words or images within the document with a Uniform Resource Locator (URL) corresponding to another file. Within the art, a tag of this particular functionality may be referred to as an “HREF” (hypertext reference) tag.

Transaction—includes any communication or agreement between two or more entities, including end users, individuals, retailers, and/or computing systems. In certain embodiments a transaction can include a financial transaction wherein a seller sells and item and a buy buys an item, where such seller may experience an increase in finances while the buyer's finances may decrease. In certain embodiments, a transaction may include a communication between a computing system and an one or more end users, or between two computing systems, a computing system and a database or data repository, two end users, two or more data repositories, etc. In additional embodiments, a transaction includes a POS transaction, where a customer places and pays for one or more items, goods, services, or products and/or access to or use of any or all of the foregoing, and/or via a website and/or using a POS terminal or POS device.

Trial Coupon—includes any offer that encourages the purchase of a new item or an item an end user has not yet tried, which offer may be presented using any applicable means, including use of an electronic or printed coupon.

Upsell—includes any offer to purchase one or more items at a full, discounted or other price including the retail price. Upsells include offers to increase an order size, quantity, type or contents of an entity's, e.g., a customer's order.

Upsell/Instruction/Commission Output device—includes, but is not limited to: a POS terminal, a website, a drive through or other digital menu board, a drive through speaker, a cell phone, telephone, pager or PDA, a kiosk, a vending machine, a customer counter display, an in-store or other digital menu board, a display built into a restaurant table, a vending machine, a speaker, or slot machine.

User—includes any entity or person including a person making use or practicing the various disclosed embodiments of the invention. The terms user and end user shall include corollary meanings.

User-Visible Text Portion—A portion of markup language-based code which specifies the text or other images to be displayed to a Web user. An example (in bold) as well as the corresponding tag (underlined) follows: Ex. <A HREF=“http://go.msn.com/npl/msnt.asp” target=”_top”><IMG SRC=“/chan/home/logo.gif” WIDTH=140 HEIGHT=60 BORDER=0 ALT=“Go to msn.com”>Microsoft Network</A>

Web Browser—A client application that enables a user to view markup language-based documents on the World Wide Web, another network, or the user's computer; utilize the hyperlinks among the documents, as well as transfer and execute files within the documents.

Web Site—A subset of the World Wide Web comprising a collection of files, documents and graphics made generally available to others through the Internet. In certain embodiments a web site may include means for conducting a transaction, including, for example, a POS transaction.

Wireless Communications Device (WCD)—A communications device that transceives via a non-wired medium, such as radio frequency. A WCD can include, but is not limited to an AM or FM radio device, a television, cell phones, portable phones, and devices, such as laptop computers and PDAs interfaced with a wireless network, for example, a LAN. Applicable formats, standards or protocols, include Ethernet (or IEEE 802.3), SAP, ATP, Bluetooth, and TCP/IP, TDMA, CDMA, and 3G.

World Wide Web—The total set of inter-linked hypertext documents residing on Hypertext

Computing. It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. A “processor” means one or more microprocessors, central processing units (CPUs), computing devices, microcontrollers, digital signal processors, or like devices or any combination thereof.

A description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software or hardware only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

Remote Connectivity means any method used by a Controller, a Display or a Server or other computing devices to communicate with other devices or networks including, but not limited to the Internet, Satellite networks, Cell Phone networks, other wireless networks and standards such as 802.11, 80211.b, 802.11g, or similar wireless LAN operating standards, or Bluetooth technologies, infrared connections, or any other similar technologies or other technologies such as those described above that permit the sending and/or receiving and/or processing of electronic information in either an encrypted or unencrypted format.

Server means one or more computing systems that include at least one of a processor, computer readable medium, or input/output capabilities and may have local or Remote Connectivity capabilities. Servers may be local or remote to Displays or both. A Server may be or include one or more of a Display and/or a Controller.

In an embodiment, a Server computer or centralized authority may not be necessary or desirable. For example, the present invention may, in an embodiment, be practiced on one or more devices without a central authority. In such an embodiment, any functions described herein as performed by the Server computer or data described as stored on the Server computer may instead be performed by or stored on one or more such devices.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

“Determining” something can be performed in a variety of manners and therefore the term “determining” (and like terms) includes calculating, computing, deriving, looking up (e.g., in a table, database or data structure), ascertaining, recognizing, and the like. A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors. The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, TDMA, CDMA, GSM, EDGE, GPRS, WCDMA, AMPS, D-AMPS, IEEE 802.11 (WI-FI), IEEE 802.3, SAP, SAS™ by IGT, OASIS™ by Aristocrat Technologies, SDS by Bally Gaming and Systems, ATP, TCP/IP, gaming device standard (GDS) published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only or the other of A and B.

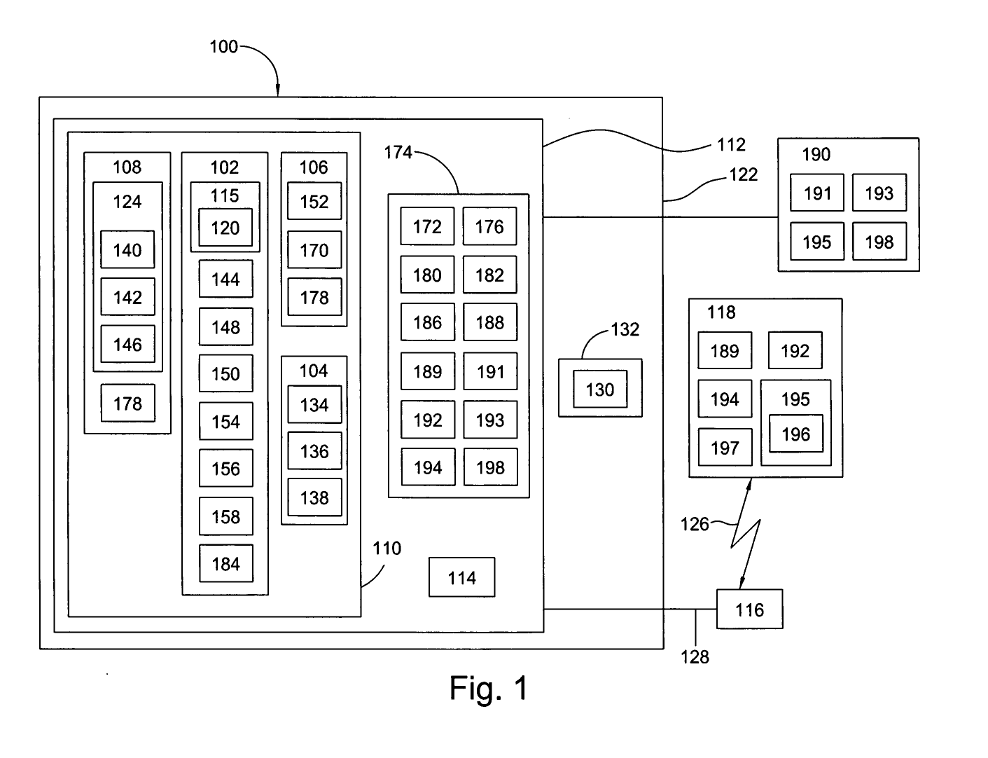

FIG. 1 is a block diagram for present invention system 100 for managing an order received from a wireless communications device (WCD). System 100 includes order element 102, location element 104, scheduling element 106, and instruction element 108, in processor 110 in at least one specially programmed general-purpose computer 112. Alternately stated, elements 102, 104, 106, and 108 and any other elements described as being in the processor are functions of the processor or are functions carried out by the processor.

The order element is arranged to receive, via interface element 114 in computer 112, transmission 115, via communication network 116, from WCD 118, the transmission including order 120 for item (not shown) at retail location 122. The location element is arranged to identify, using the interface element, when the WCD is within a predetermined location with respect to the retail location. Any means known in the art can be used to determine the respective locations of the WCD and the location and the location of the WCD with respect to the predetermined location, for example, global positioning system technology in the WCD. The communications network also can be used to locate the WCD. The scheduling element is arranged to schedule preparation of the order in response to the predetermined location. The instruction element is arranged to generate at least one instruction 124 for fulfilling the order and to transmit the at least one instruction, using the interface element.

By interface element, we mean any combination of hardware, firmware, or software in a computer used to enable communication or data transfer between the computer and a device, system, or network external to the computer. The interface element can connect with the device, system, or network external to the computer, for example, network 116, using any means known in the art, including, but not limited to a hardwire connection, an optical connection, an Internet connection, or a radio frequency connection. Processor 110 and interface element 114 can be any processor or interface element, respectively, or combination thereof, known in the art.

Computer 112 can be any computer or plurality of computers known in the art. In one embodiment, the computer is located in a retail location with which system 100 is associated, for example, location 122. In another embodiment (not shown), all or parts of the computer are remote from retail locations with which system 100 is associated. In a further embodiment, computer 112 is associated with a plurality of retail locations with which system 100 is associated. Thus, the computer provides the functionality described for more than one retail location. The computer may be located in a central location separate from the plurality of locations

A WCD is defined supra. WCD 118 can be any WCD known in the art. In one embodiment, WCD 118 is owned by, leased by, or otherwise already in possession of the end user when system 100 interfaces with the WCD. In the description that follows, it is assumed that the WCD is owned by, leased by, or otherwise already in possession of the end user when system 100 interfaces with the WCD. In general, the WCD communicates with a network, for example, network 116, via radio-frequency connection 126. Network 116 can be any network known in the art. In one embodiment, the network is located outside of the retail location, for example, the network is a commercial cellular telephone network. In one embodiment (not shown), the network is located in a retail location, for example, the network is a local network, such as a Bluetooth network. The interface element can connect with network 116 using any means known in the art, including, but not limited to a hardwire connection, an optical connection, an Internet connection, or a radio frequency connection. In the figures, a non-limiting example of a hardwire connection 128 is shown. In one embodiment, device 118 is connectable to a docking station (not shown) to further enable communication between device 118 and system 100. Any docking station or docking means known in the art can be used. That is, when the device is connected to the docking station, a link is established or continued between the device and system 100.

System 100 also includes presentation element 130 at point of sales (POS) station 132 at the retail location, arranged to receive and present the at least one instruction. Element 130 can be any device known in the art, for example, a graphical user interface (GUI), a printer, or an audio output, for example, a headset or speaker.

In a preferred embodiment, the location element is arranged to determine that the WCD is in a drive-through line (not shown) for the retail location or in a walk-up line (not shown) for the retail location. That is, the predetermined location is the drive-through line or the walk-up line. In one embodiment, the location element is arranged to determining that the WCD is in a specified position in the drive-though line or the walk-up line, respectively. For example, the location element determines that the WCD is the next position in line at a drive-through window. In another embodiment, the scheduling element is arranged to schedule in response to the specified position in the drive-though line or the walk-up line, respectively. For example, knowing where the WCD is in the line and knowing the estimated time for preparing the order, the scheduling element can determine when to start preparing the order. The relative location of the WCD can be determined using any means known in the art including, but not limited to sensors and GPS technology.

The scheduling element is arranged to schedule preparation using any means known in the art. In one embodiment, the scheduling element is arranged to schedule preparation using at least one executable 170 generated by one or both of set of rules 172 stored in memory unit 174 and artificial intelligence program 176 in the memory unit. In one embodiment, the executable is generated as disclosed by commonly-owned U.S. patent application labeled “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 112 receives modifying rule 189 from a WCD and stores the rule in memory 174. In another embodiment, the WCD is WCD 118. Element 106 modifies executable 170 using rule 189. The WCD generates rule 189 and element 106 modifies executable 170 as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, computer 190, separate from computer 112, transmits modifying rule 191 to computer 112. Computer 190 can be in location 122 (not shown) or can be in a different location. Computer 190 can be associated with a business entity associated with location 122 or can be associated with a different business entity. In another embodiment (not shown), multiple computers 190 are included and respective computers among the multiple computers can be associated with the same or different business entities. Computer 112 stores modifying rule 191 in memory 174. Element 106 modifies executable 170 using rule 191. Computer 190 generates rule 191, and element 106 modifies executable 170, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, the location element is arranged to determine whether the order is ready and is further arranged to: if the order is ready, transmit to the communication network for transmission to the WCD, using the interface element, notice 134 that the order is ready and if the order is not ready, transmit to the communication network for transmission to the WCD, using the interface element, notice 136 that the order is not ready and estimate 138 of when the order is expected to be ready.

The instruction element is arranged to generate instructions 124 using any means known in the art. In one embodiment, the instruction element is arranged to generate instructions 124 using at least one executable 178 generated by one or both of set of rules 180 stored in memory unit 174 and artificial intelligence program 182 in the memory unit. In one embodiment, the executable is generated as disclosed by commonly-owned U.S. patent application labeled “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives modifying rule 192 from a WCD and stores the rule in memory 174. In another embodiment, the WCD is WCD 118. Element 108 modifies executable 178 using rule 192. The WCD generates rule 192, and element 108 modifies executable 178 as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, computer 190 transmits modifying rule 193 to computer 112. Computer 112 stores modifying rule 193 in memory 174. Element 108 modifies executable 178, using rule 193. Computer 190 generates rule 193, and element 108 modifies executable 178, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In a first embodiment, the at least one instruction includes information 140 that the order has already been placed via the WCD. In a second embodiment, the at least one instruction includes prompt 142 to confirm that the order was placed via the WCD and the order element is arranged to receive, via the interface element, a transmission from the POS with indication 144 that the order was placed via the WCD. In a third embodiment, the at least one instruction includes prompt 146 to ask if the order was placed via the WCD. Then, the order element is arranged to receive, via the interface element, transmission 148 from the POS indicating that the order was placed via the WCD.

Payment for the order can be executed by any means known in the art. In one embodiment, the order element is arranged to receive, via the interface element, a transmission, via the communication network, from the WCD, the transmission including payment information or authorization 150 regarding the order and the at least one instruction includes directions regarding payment for the order. For example, the instruction can include information that the order is to be paid for using a specific method, for example, cash or credit card, or that the order is prepaid, for example, by credit card. System 100 can interact with payment systems (not shown) for retail location 122 by any means known in the art. In a first embodiment, all payment operations for the location are incorporated in system 100, for example, element 102 and system 100 are able to conduct the payment operations independently. In a second embodiment, some of the payment operations for the location are incorporated in system 100, some of the operations are conducted in a separate system for the retail location (not shown), and system 100 interfaces with the separate system to conduct the payment operations. Any reconciliation/payment method known in the art can be used to transfer funds between system 100 and the separate system/business entity operating the location as necessary. In a third embodiment, the payment operations for the location are separate from system 100 and system 100 acts as a conduit for those operations. That is, system 100 interfaces with the operations conducting the payment operations as needed to facilitate the transfer of data etc.

The method of payment can be any payment method known in the art and compatible with wireless communications. For example, the payment can be using a credit card or can be an account associated with the wireless device. For example, when the WCD is a cellular telephone system, the payment can be applied to the cellular telephone system account for the WCD or other payment method associated with such cellular telephone system or, as provided by an existing or provided customer account, which may be stored along with other customer or system information. In another embodiment, when an end user has agreed to provide payment methods, for example, by opting into a loyalty or other marketing program or by agreement with a cell phone or other network provider, the end user can authorize payment for the item as part of order 120. In some aspects, payment alternatives include digital wallets such as those provided by Paypal, Google, and Amazon.

In another embodiment, the scheduling element is arranged to schedule based on an estimated time of arrival for the WCD at the business location or in response to information 152 a signal transmitted from the WCD and received via the interface element. In a further embodiment, the order element is arranged to transmit, using the processor and the interface element, order confirmation 154 to the communication network for transmission to the WCD, the order confirmation including an estimated time of arrival from a location of the WCD to the business location or directions from the location of the WCD to the business location.

In one embodiment, the order element is arranged to: generate listing 156 of retail locations able to fulfill the order; transmit, using the interface element, the listing to the WCD via the communications network; and receive, using the interface element, a transmission from the WCD via the communications network, the transmission including selected retail location 158 from the listing of locations. In another embodiment, the location element is arranged to identify that the WCD is within a predetermined location with respect to the selected retail location and the display element is arranged to display the at least one instruction at a POS station at the selected retail location.

The order element is arranged to generate listing 156 using any means known in the art. In one embodiment, the order element is arranged to generate listing 156 using at least one executable 184 generated by one or both of set of rules 186 stored in memory unit 174 and artificial intelligence program 188 in the memory unit. In one embodiment, the executable is generated as disclosed by commonly-owned U.S. patent application labeled “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives modifying rule 194 from a WCD and stores the rule in memory 174. In another embodiment, the WCD is WCD 118. Element 102 modifies executable 184 using rule 194. The WCD generates rule 194, and element 102 modifies executable 184 as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, memory element 195 in WCD 118 stores rule 196. Processor 197 in the WCD implements the listing according to rule 196. The WCD generates rule 196, and operates on the listing as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, computer 190 transmits modifying rule 198 to computer 112. Computer 112 stores modifying rule 198 in memory 174. Element 102 modifies executable 184, using rule 198. Computer 190 generates rule 198, and element 102 modifies executable 184, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

It should be understood that the POS station can be manned, for example, by an employee of the retail location, or can be a self-service kiosk.

System 100 provides a means for facilitating the fulfillment at a retail location, such as a fast food restaurant, of an order sent ahead of time to the retail location from a WCD. For example, system 100 facilitates the processing, scheduling, transfer, and payment for the order. In one preferred embodiment, the system provides instructions to an employee operating a POS station at the retail location. The instructions include messages, reminders, or prompts regarding the processing, scheduling, transfer, and payment for the order. The instructions can identify for the employee that a customer being served by the employee or in line to be served by the employee has pre-placed an order using a WCD and provides an appropriate set of instructions, for example, according to the nature of the order or the payment arrangement for the order.

The following is an example of a possible sequence using system 100 at a drive-through window at a fast food restaurant. A prompt alerts an employee at the POS for the window that a WCD from which an order was transmitted is in the line. The system then determines or identifies the order associated with the WCD. If the order has not yet been prepared (this could depend, for example, on the length of the line or the preparation time needed for the order), the order is added to the order queue. The system sends a message indicating that the WCD is next in line. As the vehicle with the WCD approaches the window, the system sends a prompt for the employee to tell the customer the order has already been taken, to ask if the order was sent via the WCD, or to confirm that the order was sent via the WCD. The system also sends information to the POS regarding payment for the order, for example, if payment has already been settled using the WCD or if payment is required. The system sends a prompt for the cashier to tell the customer to proceed to the pick up line and receives from the POS a signal confirming that the employee has prompted the customer to proceed. Finally, the order is added to the pick up queue.

In a first embodiment, the system prompts the cashier (or other employee at the POS station) to confirm that the order was remotely placed. For example, a script could be presented on a screen for the POS station: “Hello, I am showing that you placed your order before you arrived, is that correct?” If the customer replies affirmatively, the cashier confirms the order. In a second embodiment, the system prompts the cashier to ask if the order is remotely placed. If the customer replies in the affirmative, the system checks the identification of the WCD (using any means known in the art) and the cashier can retrieve, confirm, or process the order. To facilitate this process, a script could be presented on a screen for the POS station: “Did you place your order before you arrived? Here it is. Did you order number 4 with extra mayo?” In a third embodiment, the system prompts the cashier to confirm the remotely placed order, for example by displaying a prompt on a screen for the POS station: “Thank you for placing your order before you arrived, you wanted a number 3 with coke. Is there anything else?”

In a preferred embodiment, the POS station is a self-serve kiosk and instructions 124 are directed to a customer who has placed an order beforehand using a WCD. The discussion above regarding the instructions with respect to a POS station manned by an employee, such as a cashier, are substantially applicable to the kiosk. For example, the location element can detect that the WCD is in the line for the kiosk and the scheduling element can operate as described supra based on that positional information. Also, prompts can be displayed or played (audio) at the kiosk to ask the customer to confirm that an order was placed using a WCD or to confirm that the order was placed using a WCD. The kiosk can accept answers or input from the customer via any means known in the art, for example, a touch screen.

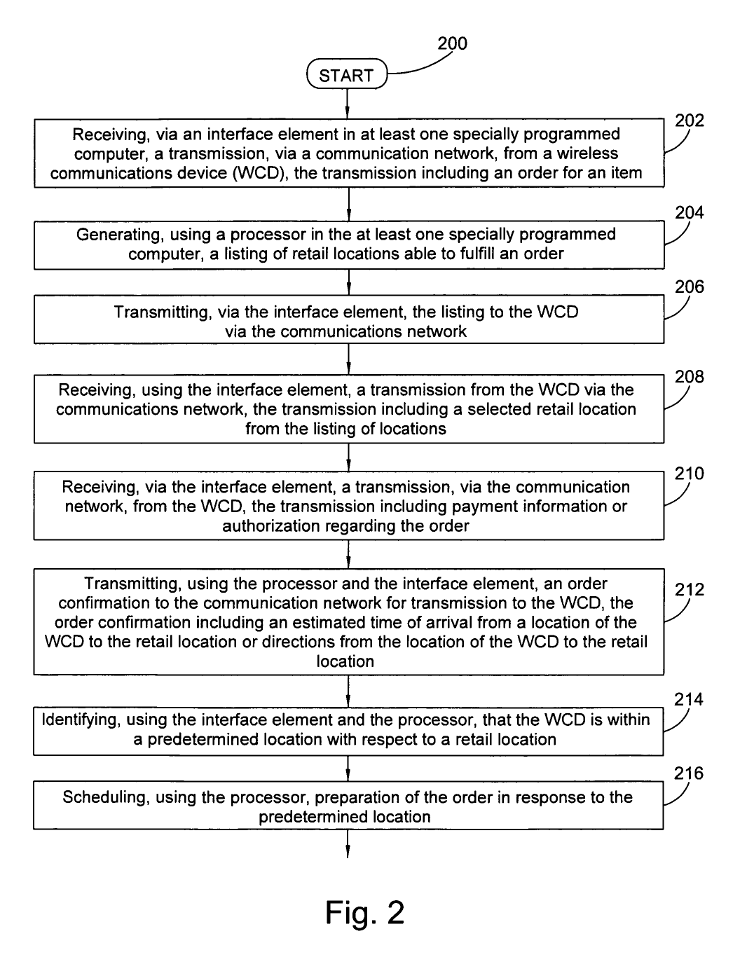

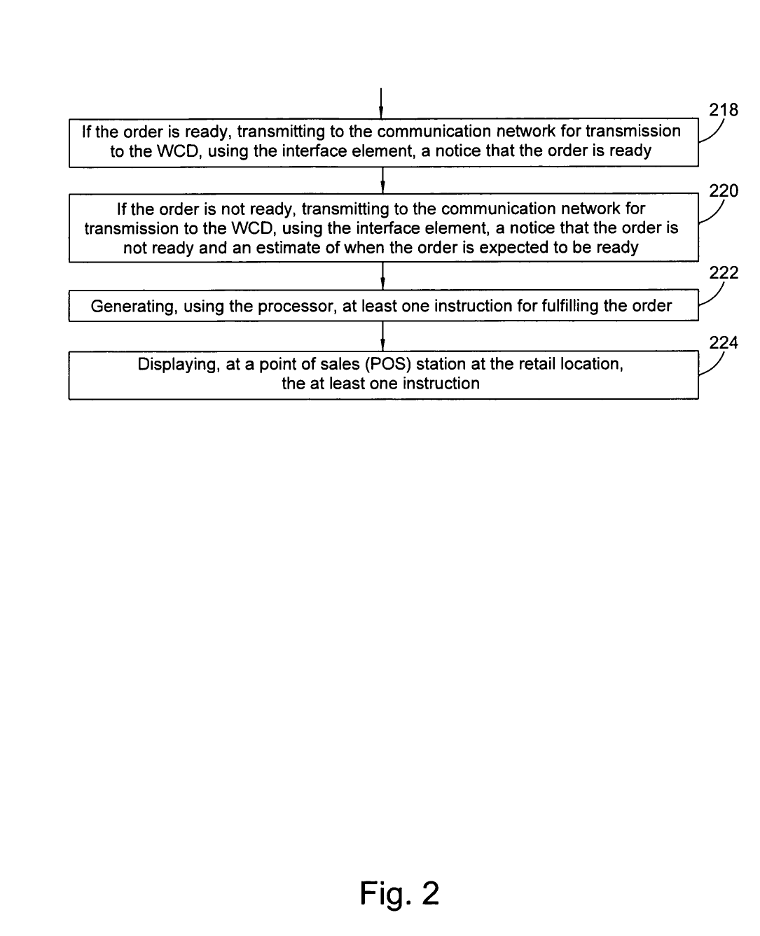

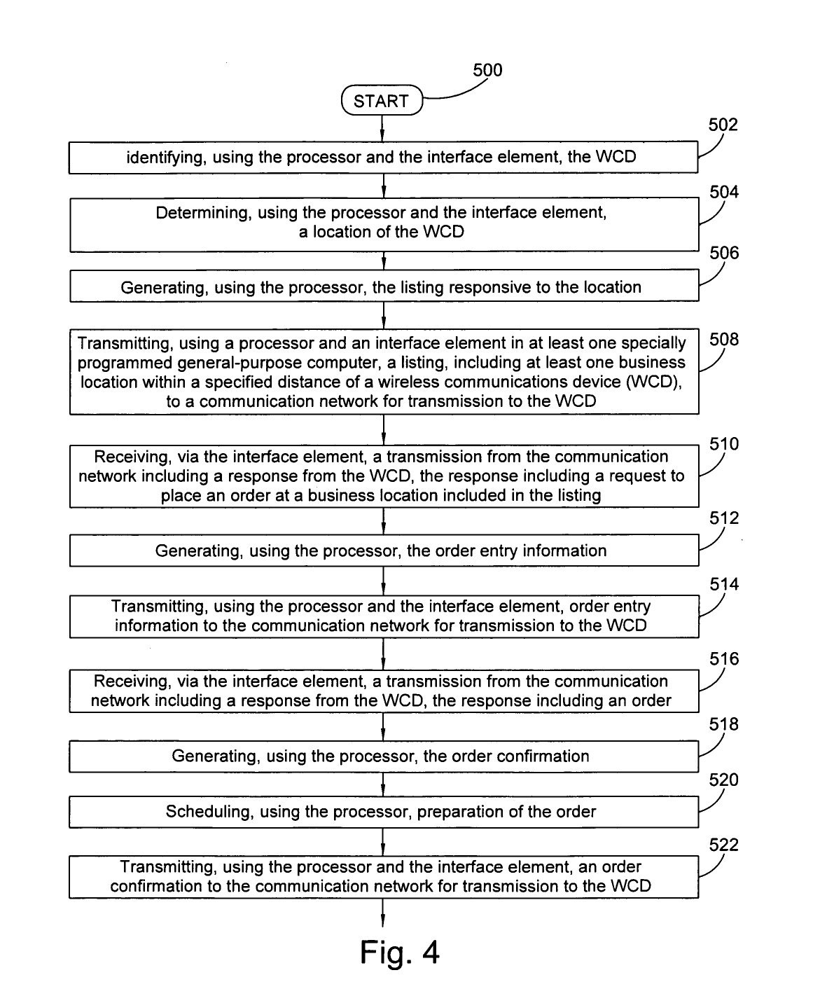

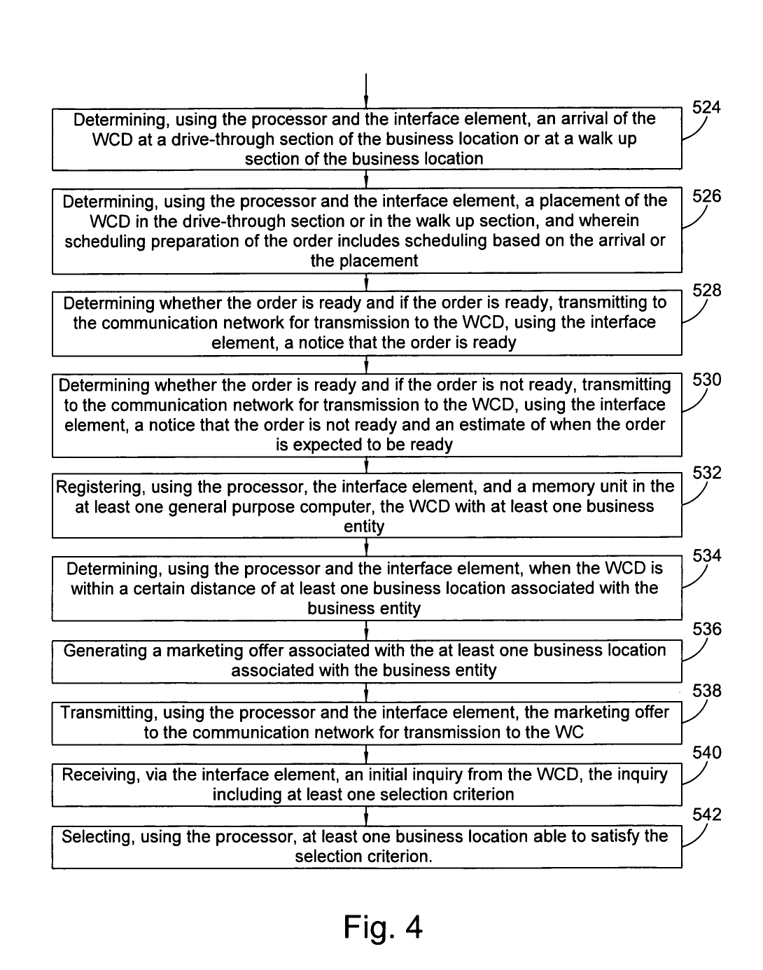

FIG. 2 is a flow chart illustrating a present invention computer-based method for managing an order received from a wireless communications device (WCD). Although the method in FIG. 2 (and FIG. 4 below) is depicted as a sequence of numbered steps for clarity, no order should be inferred from the numbering unless explicitly stated. The method starts at Step 200. Step 202 receives, via an interface element in at least one specially programmed general-purpose computer, a transmission, via a communication network, from a wireless communications device (WCD), the transmission including an order for an item. Step 214 identifies, using the interface element and a processor in the specially programmed computer, that the WCD is within a predetermined location with respect to a retail location. Step 216 schedules, using the processor, preparation of the order in response to the predetermined location. Step 222 generates, using the processor, at least one instruction for fulfilling the order. Step 224 presents, at a point of sales (POS) station at the retail location, the at least one instruction.

In one embodiment, identifying that the WCD is within a predetermined location includes determining that the WCD is in a drive-through line for the retail location or in a walk-up line for the retail location. In another embodiment, determining that the WCD is in a specified position in the walk-up line includes determining whether the order is ready and step 218, if the order is ready, transmits to the communication network for transmission to the WCD, using the interface element, a notice that the order is ready and step 220, if the order is not ready, transmits to the communication network for transmission to the WCD, using the interface element, a notice that the order is not ready and an estimate of when the order is expected to be ready.

In one embodiment, step 212 transmits, using the processor and the interface element, an order confirmation to the communication network for transmission to the WCD, the order confirmation including an estimated time of arrival from a location of the WCD to the business location or directions from the location of the WCD to the business location.

In one embodiment, step 204 generates, using the processor, a listing of retail locations able to fulfill the order; step 206 transmits, using the interface element, the listing to the WCD via the communications network; and step 208 receives, using the interface element, a transmission from the WCD via the communications network, the transmission including a selected retail location from the listing of locations. Then identifying that the WCD is within a predetermined location with respect to a retail location includes identifying that the WCD is within a predetermined location with respect to the retail location and presenting the at least one instruction includes presenting the at least one instruction at a POS station at the selected retail location.

In one embodiment, step 210 receives, via the interface element, a transmission, via the communication network, from the WCD, the transmission including payment information or authorization regarding the order and the at least one instruction includes directions regarding payment for the order.

In a first embodiment, identifying that the WCD is within a predetermined location includes determining that the WCD is in a drive-through line for the retail location or in a walk-up line for the retail location, identifying that the WCD is in a drive-through line or in a walk-up line for the retail location includes determining that the WCD is in a specified position in the drive-though line or the walk-up line, respectively. In a second embodiment, scheduling preparation of the order in response to the predetermined location includes scheduling in response to the specified position in the drive-though line or the walk-up line, respectively.

In a third embodiment, the at least one instruction includes information that the order has already been placed via the WCD, or the at least one instruction includes a prompt to confirm that the order was placed via the WCD or a prompt to ask if the order was placed via the WCD. In a fourth embodiment, scheduling includes scheduling based on an estimated time of arrival for the WCD at the business location or in response to a signal transmitted from the WCD and received via the interface element. In a fifth embodiment, the POS station is a self-serve kiosk.

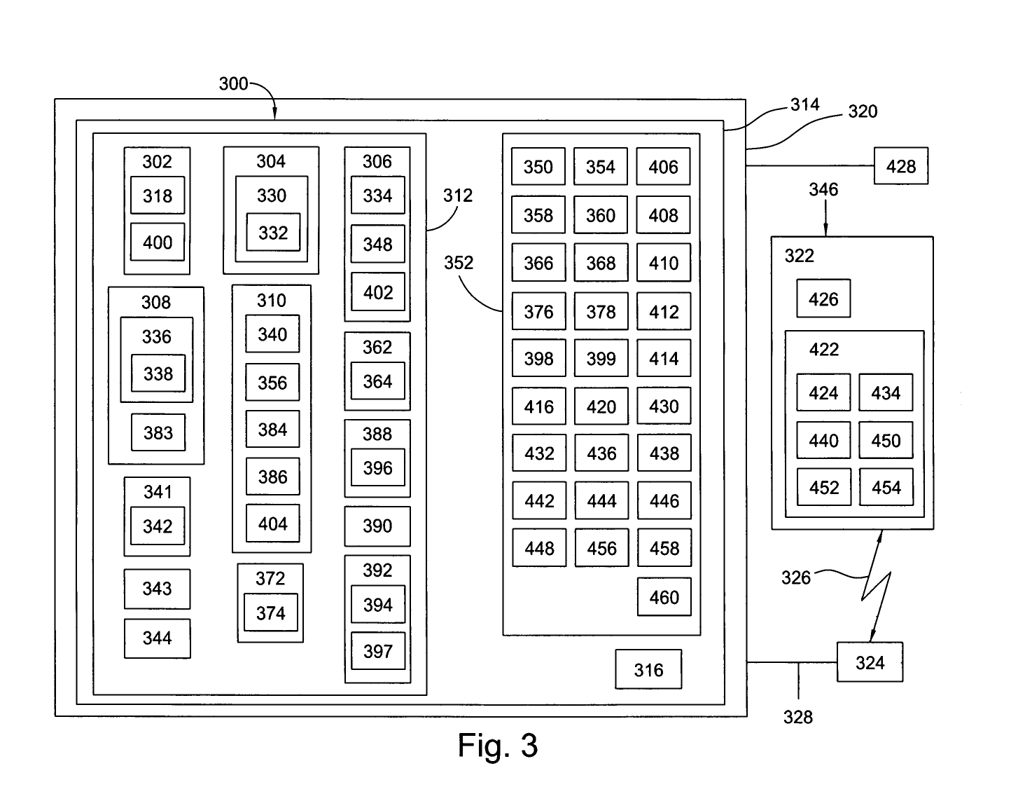

FIG. 3 is a block diagram for present invention apparatus 300 for ordering an item. Apparatus, or system, 300 includes listing element, or function, 302, request element, or function, 304, order entry element, or function, 306, response element, or function, 308, and order confirmation element, or function, 310, all in one or more processors 312 in at least one specially programmed general-purpose computer 314. Alternately stated, elements 302, 304, 306, 308, and 310, and any other elements described as being in the processor are functions of the processor or are functions carried out by the processor.

The listing element is arranged to transmit, via interface element 316 for the at least one general-purpose computer, listing 318, including at least one business, or retail, location, for example, location 320, within a specified distance of wireless communications device (WCD) 322, to communication network 324 for transmission to the WCD. Any means known in the art can be used to determine a distance between the WCD and the location as further described infra. In general, some type of agreement is in place between an operator of apparatus 300 and business locations available for inclusion in the listing. That is, some level of participation is required of the business locations. In the discussion that follows, location 320 is used as an example of a business location; however, it should be understood that system 300 is not limited to use with a single retail location. The listing also can include a prompt for information from an end user of the WCD or may prompt the end user to pose a question.

By interface element, we mean any combination of hardware, firmware, or software in a computer used to enable communication or data transfer between the computer and a device, system, or network external to the computer. The interface element can connect with the device, system, or network external to the computer, for example, network 324, using any means known in the art, including, but not limited to a hardwire connection, an optical connection, an Internet connection, or a radio frequency connection. Processor 312 and interface element 316 can be any processor or interface element, respectively, or combination thereof, known in the art.

Computer 314 can be any computer or plurality of computers known in the art. In one embodiment, the computer is located in a retail location with which system 300 is associated, for example, location 320. In another embodiment (not shown), all or parts of the computer are remote from retail locations with which system 300 is associated. In a further embodiment, computer 314 is associated with a plurality of retail locations with which system 300 is associated. Thus, the computer provides the functionality described for more than one retail location.

A WCD is defined supra. WCD 322 can be any WCD known in the art. In one embodiment, WCD 314 is owned by, leased by, or otherwise already in possession of the end user when system 300 interfaces with the WCD. In the description that follows, it is assumed that the WCD is owned by, leased by, or otherwise already in possession of the end user when system 300 interfaces with the WCD. In general, the WCD communicates with a network, for example, network 324, via radio-frequency connection 326. Network 324 can be any network known in the art. In one embodiment, the network is located outside of the retail location, for example, the network is a commercial cellular telephone network. In one embodiment (not shown), the network is located in a retail location, for example, the network is a local network, such as a Bluetooth network. The interface element can connect with network 324 using any means known in the art, including, but not limited to a hardwire connection, an optical connection, an Internet connection, or a radio frequency connection. In the figures, a non-limiting example of a hardwire connection 328 is shown. In one embodiment, device 322 is connectable to a docking station (not shown) to further enable communication between device 322 and system 300. Any docking station or docking means known in the art can be used. That is, when the device is connected to the docking station, a link is established between the device and system 300.

The request element is arranged to receive, via the interface element, a transmission from the communication network including response 330 from the WCD. The response includes request 332 to place an order at a business location included in the listing, for example, location 320. Request 332 also can include a query about availability of an item or information regarding the location, such as hours of operation. The order entry element is arranged to transmit, using the interface element, order entry information 334 to the communication network for transmission to the WCD. The response element is arranged to receive, via the interface element, a transmission from the communication network including response 336 from the WCD. In a preferred embodiment, the response includes order 338. The order includes a request to purchase one or more items or services from the business location and can include ancillary information such as a preference for obtaining the items or services, for example, where a drive-through or walk up option is preferred at the business location. The order confirmation element is arranged to transmit, using the interface element, order confirmation 340, regarding order 338, to the communication network for transmission to the WCD. For a WCD equipped with or interfaced with a printer, the order confirmation can be printed. The confirmation can include, but is not limited to: price or payment information, a reiteration of order 338, or other information as described infra.

In one embodiment, contact element 341 is arranged to receive an initial inquiry 342 from the WCD using any means known in the art. That is, rather than having system 300 transmit listing 318 to initiate contact with the WCD, the WCD first contacts system 300, for example, by placing a call to the system via network 324. Inquiry 342 can be, but is not limited to being, regarding a particular business location, a particular business entity, or a particular item. For example, the inquiry can be a request to find a location for a particular restaurant chain or could be a request to locate all restaurant chains serving a food product or meeting another criterion. In general, some type of agreement is in place between an operator of apparatus 300 and business locations available for consideration with respect to inquiry 342. That is, some level of participation is required of the business locations. In general, the inquiry includes at least one selection criterion with respect to a participating business entity, participating business location, or desired item. Element 302 is arranged to select one or more business locations satisfying the selection criterion and to include the businesses in listing 318. Then, the operation of elements 306, 308, and 310 is substantially as described supra.

Payment for the order can be executed by any means known in the art. In one embodiment, the order information includes a request to identify a payment means and element 308 is arranged to select and act on payment information included in order 338. Apparatus 300 can interact with payment systems (not shown) for business location 320 by any means known in the art. In a first embodiment, all payment operations for the location are incorporated in apparatus 300, for example, elements 308 or 310 and apparatus 300 is able to conduct the payment operations independently. In a second embodiment, some of the payment operations for the location are incorporated in apparatus 300, some of the operations are conducted in a separate system for the business location (not shown), and apparatus 300 interfaces with the separate system to conduct the payment operations. Any reconciliation/payment method known in the art can be used to transfer funds between system 300 and the separate system/business entity operating the location as necessary. In a third embodiment, the payment operations for the location are separate from apparatus 300 and apparatus 300 acts as a conduit for those operations. That is, apparatus 300 interfaces with the operations conducting the payment operations as needed to facilitate the transfer of data etc.

In one embodiment, the order confirmation includes a prompt for the end user of the WCD to provide, or otherwise permit system 300 to retrieve information and authorization regarding a method of payment for order 338. The method of payment can be any payment method known in the art and compatible with wireless communications. For example, the payment can be using a credit card or can be an account associated with the wireless device. For example, when the WCD is a cellular telephone system, the payment can be applied to the cellular telephone system account for the WCD or other payment method associated with such cellular telephone system or, as provided by an existing or provided customer account, which may be stored along with other customer or system information. In another embodiment, when an end user has agreed to provide payment methods, for example, by opting into a loyalty or other marketing program or by agreement with a cell phone or other network provider, the end user can authorize payment for the item as part of order 338. In some aspects, payment alternatives include digital wallets such as those provided by Paypal, Google, and Amazon.

In a preferred embodiment, system 300 includes identity element 343 and location element 344, both in the processor. The identity element is arranged to identify, using the interface element, the WCD. The location element is arranged to determine, using the interface element, location 346 of the WCD. The location of the WCD can be determined using any means known in the art, including, but not limited to, GPS technology and information from network 322. The listing element is arranged to generate the listing responsive to the location.

In a preferred embodiment, the order entry element is arranged to generate the order entry information using any means known in the art. In one embodiment, the order entry element is arranged to generate the order entry information using at least one executable 348 generated by one or both of set of rules 350 stored in memory unit 352 and artificial intelligence program 354 in the memory unit. In one embodiment, the executable is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 312 receives modifying rule 420 from a WCD and stores the rule in memory 352. In another embodiment, the WCD is WCD 322. Element 106 modifies executable 348, using rule 420. The WCD generates rule 420, and element 306 modifies executable 348, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, memory element 422 in WCD 322 stores rule 424. Processor 426 in the WCD implements information 334 according to rule 424. The WCD generates rule 424 and operates on information 334 as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, computer 428, separate from computer 312, transmits modifying rule 430 to computer 312. Computer 428 can be in location 320 (not shown) or can be in a different location. Computer 428 can be associated with a business entity associated with location 320 or can be associated with a different business entity. In another embodiment (not shown), multiple computers 428 are included and respective computers among the multiple computers can be associated with the same or different business entities. Computer 312 stores modifying rule 430 in memory 352. Element 306 modifies executable 348 using rule 430. Computer 428 generates rule 430, and element 306 modifies executable 348, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In a preferred embodiment, the order confirmation element is arranged to generate the order confirmation using any means known in the art. In another embodiment, the order confirmation element is arranged to generate the order confirmation using at least one executable 356 generated by one or both of set of rules 358 stored in memory unit 352 and artificial intelligence program 360 in the memory unit. In one embodiment, the executable is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 312 receives modifying rule 432 from a WCD and stores the rule in memory 352. In another embodiment, the WCD is WCD 322. Element 310 modifies executable 356, using rule 432. The WCD generates rule 432, and element 310 modifies executable 356, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, memory element 422 in WCD 322 stores rule 434. Processor 426 in the WCD implements information 334 according to rule 424. The WCD generates rule 424 and operates on information 334 as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, computer 428 transmits modifying rule 436 to computer 312. Computer 312 stores the modifying rule 436 in memory 352. Element 310 modifies executable 356, using rule 436. Computer 428 generates rules 436, and element 310 modifies executable 356, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In a preferred embodiment, apparatus 300 includes schedule element 362, in the processor, arranged to schedule preparation, assembly, storage, or retrieval of the order using any means known in the art. In a further embodiment, the schedule element is arranged to schedule preparation using at least one executable 364 generated by one or both of set of rules 366 stored in memory unit 352 and artificial intelligence program 368 in the memory unit. In a first embodiment, the schedule element is arranged to schedule based on an estimated time of arrival for the WCD at the business location or in response to a signal transmitted from the WCD and received via the interface element.

In one embodiment, system 300 includes arrival element 370, in the processor, arranged to determine, using the interface element, an arrival of the WCD at a drive-through section (not shown) of the business location or at a walk up section (not shown) of the business location. In another embodiment, system 300 includes placement element 372, in the processor, arranged to determine, using the interface element, a placement of the WCD in the drive-through section or in the walk up section. In a further embodiment, schedule element 362 is arranged to schedule preparation of the order based on the arrival or the placement. That is, based on information from elements 370 or 372, the schedule element determines when to prepare, assembly, store, retrieve, or present the order. For example, the schedule element can use the arrival and placement information to determine when a customer associated with the WCD will be in position to accept the order. The arrival and placement information can be obtained or derived using any means known in the art, for example, GPS technology in the WCD or sensors in the respective sections.

The arrival and placement elements are arranged to generate the arrival and placement information using any means known in the art. In another embodiment, the arrival and placement elements are arranged to generate the arrival and placement information using at least one executable 374 generated by one or both of set of rules 376 stored in memory unit 352 and artificial intelligence program 378 in the memory unit. In one embodiment, the executable is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In a further embodiment, the arrival element is arranged to determine how many vehicles are in a line at the drive-through section and the schedule element is arranged to schedule responsive to the number of vehicles in the line at the drive-through section. For example, the estimated time at which a vehicle housing the WCD will be in a position to receive the order can be estimated based on the number of vehicles in line before the vehicle housing the WCD. In yet another embodiment, the arrival element is arranged to determine, for arrival of the WCD at a walk up section, whether the order is ready. If the order is ready, the arrival element transmits to the communication network for transmission to the WCD, using the interface element, notice 380 that the order is ready. If the order is not ready, the arrival element transmits to the communication network for transmission to the WCD, using the interface element, notice 382 that the order is not ready. Notice 382 includes an estimate, generated by the schedule element, as to when the order is expected to be ready. In yet another embodiment, when an order is not yet ready for an end user, receiving element 308 is arranged to receive, via the interface element, transmission 383 from the communication network including information regarding a location of the WCD in or around the location. For example, the end user can specify a table in the location to which the order can be brought when ready.

In one embodiment, the order confirmation element is arranged to transmit, to the communication network for transmission to the WCD, using the interface element, an estimated time of arrival 384 from location 346 of the WCD to the business location. In another embodiment the order confirmation element is arranged to transmit to the communication network for transmission to the WCD, using the interface element, directions 386 from the location of the WCD to the business location.

In another embodiment, apparatus 300 includes registration element 388, in the processor, arranged to register, using memory unit 352, the WCD with at least one participating business entity (not shown). In a further embodiment, the at least one business entity is associated with a business location in the listing. The at least business entity is associated with one or more business locations and can be an owner or operator of the locations or could be a third party hired by the owner or operator of the location to perform the registration functions described. Any means known in the art can be used to register the WCD.

In a further embodiment, the apparatus also includes locating element 390 and offer element 392, both in the processor. The locating element is arranged to determining, using the interface element, when the WCD is within a certain distance of at least one business location associated with the business entity with which the WCD is registered. The location of the WCD can be determined using any means known in the art, including, but not limited to, GPS technology and information from network 322. The offer element is arranged to generate and transmit, using the interface element, marketing offer 394 associated with the at least one business location associated with the business entity with which the WCD is registered to the communication network for transmission to the WCD. In yet another embodiment, the registration includes at least one preference 396, the at least one business location is selected as being able to satisfy a preference from the at least one preference, and the marketing offer is associated with the at least one business location able to satisfy a preference. That is, the offer element correlates one or more preferences in the WCD's registration with business locations able to meet the one or more preferences, the locating element locates the WCD with respect to those business locations, and the offer element generates and transmits offers related to the preferences and the businesses able to satisfy the preferences.

The offer element is arranged to generate the offer using any means known in the art. In another embodiment, the offer element is arranged to generate the offer using at least one executable 397 generated by one or both of set of rules 398 stored in memory unit 352 and artificial intelligence program 399 in the memory unit. In a further embodiment, the executable is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 312 receives modifying rule 438 from a WCD and stores the rule in memory 352. In another embodiment, the WCD is WCD 322. Element 392 modifies executable 397, using rule 438. The WCD generates rule 438, and element 392 modifies executable 397, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, memory element 422 in WCD 322 stores rule 440. Processor 426 in the WCD implements offer 394 according to rule 440. The WCD generates rule 440, and operates on offer 394 as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, computer 428 transmits modifying rule 442 to computer 312. Computer 312 stores modifying rule 442 in memory 352. Element 392 modifies executable 397, using rule 442. Computer 428 generates rule 442, and element 392 modifies executable 397, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, the listing includes at least one marketing offer, the order entry information includes at least one marketing offer, or the order confirmation includes at least one marketing offer. The marketing offers can be any marketing offers known in the art. The same or different marketing offers can be included with the listing, order entry information, and order confirmation. Any means known in the art can be used to generate the marketing offers. In another embodiment, elements 302, 306, and 310 use at least one executable 400, 402, and 404, respectively, generated by one or both of set of rules 406, 408, and 410, respectively, stored in memory unit 352 and artificial intelligence programs 412, 414, and 416, respectively, in the memory unit. In one embodiment, the executables are generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 312 receives modifying rules 444, 446, or 448 from a WCD and stores the rules in memory 352. In another embodiment, the WCD is WCD 322. Elements 302, 306, and 310 modify executables 400, 402, and 404, using rules 444, 446, and 448, respectively. The WCD generates rules 444, 446, and 448, and elements 302, 306, and 310 modify executables 400, 402, and 404, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, memory element 422 in WCD 322 stores rules 450, 452, or 454. Processor 426 in the WCD implements the respective marketing offers according to rules 450, 452, and 454. The WCD generates rules 450, 452, and 454, and operates on the respective marketing offers as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, computer 428 transmits modifying rules 456, 458, or 460 to computer 312. Computer 312 stores the modifying rules in memory 352. Elements 302, 306, and 310 modify executables 400, 402, and 404, using rules 456, 458, and 460, respectively. The computer generates rules 456, 458, and 460, and elements 302, 306, and 310 modify executables 400, 402, and 404, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

It should be understood that the locating element can determine the distance of the WCD from more than one business location. It also should be understood that the offer element can generate and transmit more than one offer for a business location and can generate respective offers for more than one business location or entity. It also should be understood that a plurality of distance and offer criteria and metrics can be used by the location and offer elements to determine a distance to use and to generate an offer, respectively. The criteria and metrics can include, but are not limited to, information specific to operations at a particular business entity or business location, geographical information, and temporal aspects, such as time of day.

It should be understood that apparatus 300 can be operated by the same business entity operating or owning a business location using the system, or can be operated by a third party different than the business entity operating or owning the business location using the system. In one embodiment, third party operates system 300 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that apparatus 300 can be integral with a computer operating system for a business location, for example, location 320 or with a business entity operating the business location. It also should be understood that apparatus can be wholly or partly separate from the computer operating system for a business location, for example, location 320 or with a business entity operating the business location.

In one embodiment, apparatus 300 is interfaced with one or more POS stations in the business location and provides various prompts and data for display or presentation at the stations. For example, information correlating an order with a location in a queue can be presented on a GUI for the station or information directing a cashier as to how to interact with an end user of the WCD can be presented on the GUI. For example, the cashier can be prompted to advise an end user of the WCD to proceed in a drive-through queue or to come to a walk up counter.

FIG. 4 is a flow chart illustrating a present invention computer-based method for ordering an item. The method starts at Step 500. Step 508 transmits using a processor and an interface element in at least one specially programmed general-purpose computer, a listing, including at least one business location within a specified distance of a wireless communications device (WCD), to a communication network for transmission to the WCD. Step 510 receives, via the interface element, a transmission from the communication network including a response from the WCD, the response including a request to place an order at a business location included in the listing. Step 514 transmits, using the processor and the interface element, order entry information to the communication network for transmission to the WCD. Step 516 receives, via the interface element, a transmission from the communication network including a response from the WCD, the response including an order. Step 522 transmits, using the processor and the interface element, an order confirmation to the communication network for transmission to the WCD.

In a preferred embodiment, step 502 identifies, using the processor and the interface element, the WCD; step 504 determines, using the processor and the interface element, a location of the WCD; and step 506 generates, using the processor, the listing responsive to the location. In a preferred embodiment, step 512 generates, using the processor, the order entry information and step 518 generates, using the processor, the order confirmation. In a preferred embodiment step 520 schedules, using the processor, preparation of the order.

In one embodiment, step 524 determines, using the processor and the interface element, an arrival of the WCD at a drive-through section of the business location or at a walk up section of the business location or step 526 determines, using the processor and the interface element, a placement of the WCD in the drive-through section or in the walk up section. Then, scheduling preparation of the order includes scheduling based on the arrival or the placement. In another embodiment, determining an arrival of the WCD at a walk up section includes determining whether the order is ready. If the order is ready, step 528 transmits to the communication network for transmission to the WCD, using the interface element, a notice that the order is ready. If the order is not ready, step 530 transmits to the communication network for transmission to the WCD, using the interface element, a notice that the order is not ready and an estimate of when the order is expected to be ready.

In one embodiment, step 532 registers, using the processor, the interface element, and a memory unit in the at least one general purpose computer, the WCD with at least one business entity; step 534 determines, using the processor and the interface element, when the WCD is within a certain distance of at least one business location associated with the business entity; step 536 generates a marketing offer associated with the at least one business location associated with the business entity; and step 538 transmits, using the processor and the interface element, the marketing offer to the communication network for transmission to the WCD. In another embodiment, step 540 receives, via the interface element, an initial inquiry from the WCD, the inquiry including at least one selection criterion and step 542 selects, using the processor, at least one business location able to satisfy the selection criterion.

In a first embodiment, generating the order entry information includes using at least one executable generated by one or both of a set of rules stored in a memory unit for the at least one general-purpose computer and an artificial intelligence program stored in the memory unit. In a second embodiment, generating the order confirmation includes using at least one executable generated by one or both of a set of rules stored in a memory unit for the at least one general-purpose computer and an artificial intelligence program stored in the memory unit. In a third embodiment, scheduling preparation of the order includes using at least one executable generated by one or both of a set of rules stored in a memory unit for the at least one general-purpose computer and an artificial intelligence program stored in the memory unit.

In a fourth embodiment, scheduling preparation of the order includes scheduling based on an estimated time of arrival for the WCD at the business location or in response to a signal transmitted from the WCD and received via the interface element. In a fifth embodiment, determining an arrival of the WCD includes using at least one executable generated by one or both of a set of rules stored in a memory unit for the at least one general-purpose computer and an artificial intelligence program stored in the memory unit. In a sixth embodiment, determining an arrival of the WCD at a drive-through section includes determining how many vehicles are in a line at the drive-through section and scheduling preparation of the order includes scheduling responsive to the number of vehicles in the line at the drive-through section. In a seventh embodiment, when an order is not yet ready for an end user, receiving a request to place an order includes receiving, via the interface element, a transmission from the communication network including information regarding a location of the WCD in or around the location. In an eighth embodiment, transmitting an order confirmation includes: transmitting to the communication network for transmission to the WCD, using the interface element, an estimated time of arrival from a location of the WCD to the business location; or transmitting to the communication network for transmission to the WCD, using the interface element, directions from the location of the WCD to the business location.

In a ninth embodiment, registering includes specifying at least one preference and the at least one business location is able to satisfy a preference from among the at least one preference. In a tenth embodiment, generating a marketing offer includes generating the marketing offer using at least one executable generated by one or both of a set of rules stored in the memory unit and an artificial intelligence program stored in the memory unit. In an eleventh embodiment, transmitting a listing includes transmitting a listing of the at least one business location able to satisfy the selection criterion. In a twelfth embodiment, the listing includes at least one first marketing offer, the order entry information includes at least one second marketing offer, or the order confirmation includes at least one third marketing offer.

It should be understood that various storage and removal operations, not explicitly described above, involving memory elements 174 or 352 are possible, as known in the art, with respect to the operation of systems 100 and 300, respectively. For example, outputs from and inputs to the respective general-purpose computers or the WCDs can be stored and retrieved from the respective memory elements.

It should be understood that the examples above regarding executables are non-limiting, are meant to provide only a broad overview, and do not address the number, complexity, structure, or interrelationships of the operations included in the actual generation of the executables.

It should be understood that the various sets of rules described above can be combined in a single set of rules (not shown) and that subsets of the sets of rules described above can be combined in respective sets of rules (not shown). In like manner, the various artificial programs described above can be combined in a single program (not shown) and that subsets of the artificial intelligence programs described above can be combined in respective programs (not shown).

The following is a listing of exemplary hardware and software that can be used in a present invention method or system. It should be understood that a present invention method or system is not limited to any or all of the hardware or software shown and that other hardware and software are included in the spirit and scope of the claimed invention.

Ordering/Central System
Order taking program
Time estimate program

Restaurant System 1-n
Receive Order Program
Assemble Order Program

GPS Unit 1-n
Receive Order Program
Determine Location Program
Provide directions Program
Output Location Program

The following is a listing of exemplary data bases that can be used in a present invention method or system. It should be understood that a present invention method or system is not limited to any or all of the databases shown and that other databases are included in the spirit and scope of the claimed invention.

Customer Database
Customer ID
GPS Unit 1-n
Transaction History
Billing Information
Order Preferences

GPS Unit Database
Unit ID
Customer ID
Account ID
Account Preferences

Order/Transaction Database
Time
Date
Type
GPS unit order?
Items 1-n
Price
Pick up info
Estimated pick up time
Requested pick up time
Time Picked up
Pick up venue
Payment info

Inventory Database
Item ID
Item descriptor
Unit price (if ordered from GPS unit)
Menu board price

Drive Through Queue Database
Queue ID
Order Info
Position
Pre Order?

Walk Up Queue Database
Queue ID
Order Info
Position
Pre Order?
Order Complete instructions

Time estimate information and rules database
Rule ID
Rule descriptor
Rule conditions

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A method for managing an order received from a wireless communications device (WCD), comprising the steps of:
receiving, via an interface element in at least one specially programmed general-purpose computer, a transmission, via a communication network, from a wireless communications device (WCD), the transmission including an order for an item;
identifying, using the interface element and a processor in the specially programmed computer, that the WCD is within a predetermined location with respect to a retail location;
scheduling, using the processor, preparation of the order in response to the predetermined location;
generating, using the processor, at least one instruction for fulfilling the order; and,
presenting, at a point of sales (POS) station at the retail location, the at least one instruction.

2. The method of claim 1 wherein identifying that the WCD is within a predetermined location includes determining that the WCD is in a drive-through line for the retail location or in a walk-up line for the retail location.

3. The method of claim 2 wherein identifying that the WCD is in a drive-through line or in a walk-up line for the retail location includes determining that the WCD is in a specified position in the drive-though line or the walk-up line, respectively.

4. The method of claim 3 wherein scheduling preparation of the order in response to the predetermined location includes scheduling in response to the specified position in the drive-though line or the walk-up line, respectively.

5. The method of claim 4 wherein determining that the WCD is in a specified position in the walk-up line includes determining whether the order is ready and the method including:
if the order is ready, transmitting to the communication network for transmission to the WCD, using the interface element, a notice that the order is ready; and,
if the order is not ready, transmitting to the communication network for transmission to the WCD, using the interface element, a notice that the order is not ready and an estimate of when the order is expected to be ready.

6. The method of claim 1 wherein the at least one instruction includes information that the order has already been placed via the WCD.

7. The method of claim 1 wherein the at least one instruction includes a prompt to confirm that the order was placed via the WCD or a prompt to ask if the order was placed via the WCD.

8. The method of claim 1 including the step of receiving, via the interface element, a transmission, via the communication network, from the WCD, the transmission including payment information or authorization regarding the order and wherein the at least one instruction includes information regarding payment for the order.

9. The method of claim 1 wherein scheduling includes scheduling based on an estimated time of arrival for the WCD at the business location or in response to a signal transmitted from the WCD and received via the interface element.

10. The method of claim 1 including the steps of:
transmitting, using the processor and the interface element, an order confirmation to the communication network for transmission to the WCD, the order confirmation including an estimated time of arrival from a location of the WCD to the business location or directions from the location of the WCD to the business location.

11. The method of claim 1 wherein the POS station is manned or is a self-service kiosk.

12. The method of claim 1 including the steps of:
generating, using the processor, a listing of retail locations able to fulfill the order;
transmitting, using the interface element, the listing to the WCD via the communications network; and,
receiving, using the interface element, a transmission from the WCD via the communications network, the transmission including a selected retail location from the listing of locations and wherein identifying that the WCD is within a predetermined location with respect to a retail location includes identifying that the WCD is within a predetermined location with respect to the retail location and wherein presenting the at least one instruction includes presenting the at least one instruction at a POS station at the selected retail location.

13. A system for managing an order received from a wireless communications device (WCD), comprising:
an order element, in a processor in at least one specially programmed general-purpose computer, arranged to receive, via an interface element in the at least one specially programmed general-purpose computer, a transmission, via a communication network, from a WCD, the transmission including an order for an item at a retail location;
a location element, in the processor, arranged to identify, using the interface element and the processor, that the WCD is within a predetermined location with respect to the retail location;
a scheduling element, in the processor, arranged to schedule preparation of the order in response to the predetermined location;
an instruction element, in the processor, arranged to generate at least one instruction for fulfilling the order and to transmit the at least one instruction, using the interface element; and,
a presentation element, at a point of sales (POS) station at the retail location, arranged to receive and present the at least one instruction.

14. The system of claim 13 wherein the location element is arranged to determine that the WCD is in a drive-through line for the retail location or walk-up line for the retail location.

15. The system of claim 14 wherein the location element is arranged to determining that the WCD is in a specified position in the drive-though line or the walk-up line, respectively.

16. The system of claim 15 wherein the scheduling element is arranged to schedule in response to the specified position in the drive-though line or the walk-up line, respectively.

17. The system of claim 16 wherein the location element is arranged to determine whether the order is ready and is further arranged to:
if the order is ready, transmit to the communication network for transmission to the WCD, using the interface element, a notice that the order is ready; and,
if the order is not ready, transmit to the communication network for transmission to the WCD, using the interface element, a notice that the order is not ready and an estimate of when the order is expected to be ready.

18. The system of claim 13 wherein the at least one instruction includes information that the order has already been placed via the WCD.

19. The system of claim 13 wherein the at least one instruction includes a prompt to confirm that the order was placed via the WCD and wherein the order element is arranged to receive, via the interface element, a transmission from the POS indicating that the order was placed via the WCD.

20. The system of claim 13 wherein the at least one instruction includes a prompt to ask if the order was placed via the WCD and wherein the order element is arranged to receive, via the interface element, a transmission from the POS indicating that the order was placed via the WCD.

21. The system of claim 13 wherein the order element is arranged to receive, via the interface element, a transmission, via the communication network, from the WCD, the transmission including payment information or authorization regarding the order and wherein the at least one instruction includes directions regarding payment for the order.

22. The system of claim 13 wherein the scheduling element is arranged to schedule based on an estimated time of arrival for the WCD at the business location or in response to a signal transmitted from the WCD and received via the interface element.

23. The system of claim 13 wherein the order element is arranged to transmit, using the processor and the interface element, an order confirmation to the communication network for transmission to the WCD, the order confirmation including an estimated time of arrival from a location of the WCD to the business location or directions from the location of the WCD to the business location.

24. The system of claim 13 wherein the POS station is manned or is a self-service kiosk.

25. The system of claim 13 wherein the order element is arranged to:
generate, using the processor, a listing of retail locations able to fulfill the order;
transmit, using the interface element, the listing to the WCD via the communications network; and,
receive, using the interface element, a transmission from the WCD via the communications network, the transmission including a selected retail location from the listing of locations and wherein the location element is arranged to identify that the WCD is within a predetermined location with respect to the retail location and the display element is arranged to display the at least one instruction at a POS station at the selected retail location.
